(19) United States
(12) Patent Application Publication
(10) Pub. No.: US 2013/0283083 A1
(43) Pub. Date: Oct. 24, 2013

(54) MAINTAINING OPERATIONAL STABILITY ON A SYSTEM ON A CHIP

(71) Applicants: Reed D. Vilhauer, Portland, OR (US); William T. Glennan, Folsom, CA (US)

(72) Inventors: Reed D. Vilhauer, Portland, OR (US); William T. Glennan, Folsom, CA (US)

(21) Appl. No.: 13/976,019

(22) PCT Filed: Sep. 30, 2011
(86) PCT No.: PCT/US11/54284

§ 371 Date: Jun. 25, 2013

(51) Int. Cl. G06F 1/28

(52) U.S. Cl. CPC G06F 1/28
USPC 713/340

(57) ABSTRACT

Various embodiments are directed to maintaining operational stability for a system on a chip (SOC). A power management integrated circuit (PMIC) includes comparator circuits operative to monitor a current level on a power supply rail of the SOC. An interrupt management component may create an interrupt when the monitored current level crosses the threshold setting. The interrupt may indicate whether the current level has crossed the threshold setting into or out of excessive current levels. A microcontroller on the SOC coupled with the PMIC via a low latency interrupt channel over a communication interface may receive and interpret the interrupt. The microcontroller may be operative to change an operating point of one or more components on the SOC in response to the interrupt to alleviate an overcurrent situation.

### BACKGROUND

Many existing and forthcoming system on a chip (SOC) architectures deliver increasing levels of central processing unit (CPU), graphics, and image processing capabilities that have never been seen before in the industry. Due to size and form factor constraints, these systems continue to be run from single cell lithium ion (Li-Ion) type batteries with inherent internal resistance. Significant output voltage droop under high power surges can occur, risking operational stability of system components if minimum voltage requirements are not maintained. The SOC's dynamic power range can consume large amounts of power at any given time for high compute or graphics performance scenarios. Under certain PVT (process, voltage, temperature) conditions, the SOC may exceed operational current levels and, as a result, could crash the system due to battery voltage droops. Accordingly, there may be a need for improved techniques to solve these and other problems.

### BRIEF DESCRIPTION OF THE DRAWINGS

FIG. 1 illustrates one embodiment of a SOC architecture.

FIG. 2 illustrates one embodiment of comparator logic circuits.

FIG. 3 illustrates one embodiment of a logic circuit to determine whether an interrupt should be generated.

FIG. 4 illustrates one embodiment of a timing diagram for monitoring and reacting to current changes on the VCC rail of the SOC.

FIG. 5 illustrates one embodiment of a timing diagram for monitoring and reacting to current changes on the VNN rail of the SOC.

FIG. 6 illustrates one embodiment of a logic flow diagram.

### DETAILED DESCRIPTION

In various embodiments, a current monitoring and interrupt scheme may address common deficiencies associated with operating a SOC.

The SOC may utilize, in some embodiments, one or more configurable comparator circuits that monitor the current levels on power supply rails such as, for instance, the VCC and VNN rails, continuously in order to provide the SOC with a proactive power reduction mechanism. Whenever the current on these rails exceeds a programmable comparator trip point acting as a threshold setting, a power management integrated circuit (PMIC) may quickly send a low latency alert interrupt to the SOC over a host communication interface.

As an illustrative example, the host communication interface may be the Serial Voltage Identification (SVID) interface as defined in the Intel® Mobile Voltage Positioning (IMVP) 7 specification. However, any industry standard communication interface with a low latency interrupt or bus mastering mechanism may be used. In the case of IMVP7, the interrupt message may be sent over SVID using special status bits in the IMVP7 register space to alert the SOC of the overcurrent condition on the power supply rails. A similar interrupt mechanism may be used in other communication interfaces.

The PMIC may not actively attempt to limit current or reduce voltage on VCC and/or VNN because it has no knowledge of the SOC's present activity. Rather, the PMIC allows the SOC to interpret an interrupt and lower or “throttle” performance as appropriate given the overall SOC circumstances to reduce power consumption.

Once an alert interrupt is sent over the SVID interface, a microcontroller on the SOC may quickly determine the best course of action after determining whether the interrupt represents an overcurrent event on VCC, VNN or both. The SOC may attempt to throttle its CPU, graphics processor (GFX), or other SOC component(s) powered by VCC or VNN to an operating point that may drop the VCC and/or VNN current consumption levels below the threshold setting without impacting the user experience. In more severe scenarios, the microcontroller in the SOC may allow a perceivable performance degradation or disable specific functionality through power gating to avoid a system crash. The microcontroller may have contextual knowledge as to what the SOC may be presently doing to help decide the best course of action.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

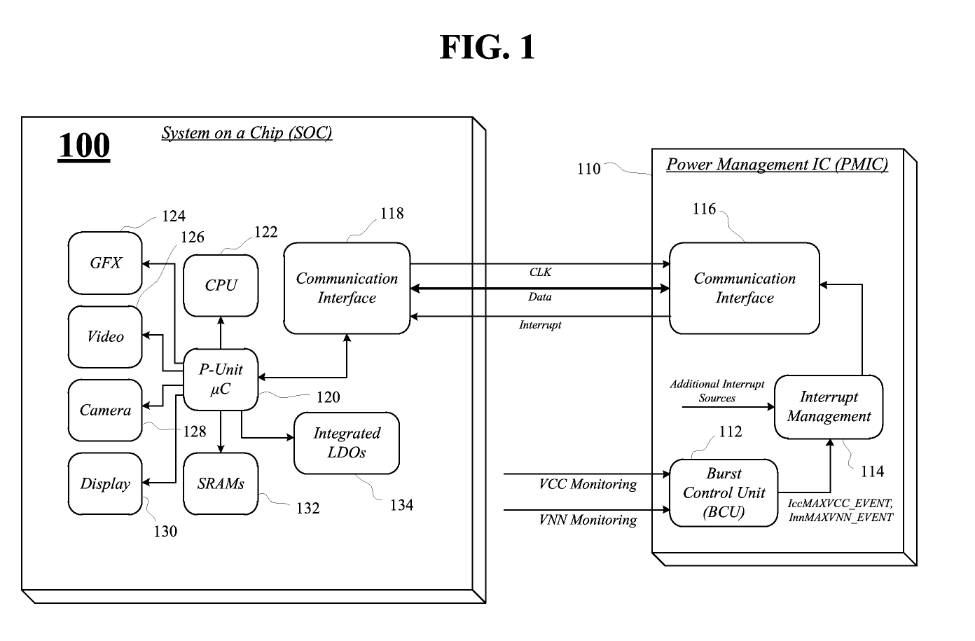

FIG. 1 illustrates one embodiment of a SOC 100 architecture. The SOC 100 architecture illustrated herein may include components such as a communication interface 118 in communication with a microcontroller 120. The microcontroller 120 may be operatively communicable with several other components including a CPU 122, a graphics processor (GFX) 124 a video component 126, a camera 128, a display 130, one or more static random access memories (SRAMs) 132 and one or more integrated low dropout regulators (LDOs) 134. For this particular collection of components, the CPU 122 is powered by the VCC rail while the GFX 124, video component 126, camera 126, display 130, SRAMs 132 and LDOs 134 are powered by the VNN rail. The SOC 100 may be communicatively coupled with a power management integrated circuit (PMIC) 110.

The PMIC 110 may include additional components such as a burst control unit (BCU) 112, an interrupt management component 114, and a communication interface 116. The BCU 112 may be operative to receive and process data from one or more comparators indicative of current levels on power supply rails such as a VCC rail and a VNN rail of the SOC 100. The outcome of such current monitoring may be sent to the interrupt management component 114 for further processing. The interrupt management component 114 may be operative to create an interrupt when the monitored current level crosses the threshold setting. The threshold setting may also be referred to as a programmable trip point. The interrupt may include data indicative of whether the current level for the VCC rail or the VNN rail has crossed the threshold setting into an excessive level or has crossed the threshold setting back into a normal level. The interrupt may then be forwarded to the communication interface 114 on PMIC 110. The communication interface 114 may then forward the interrupt out of the PMIC 110 to the SOC 100.

This particular collection of components on SOC 100 is exemplary. Other components or combinations of components may be utilized depending on the specific environment and function of the SOC. The embodiments are not limited to this example.

The communication interface 118 on SOC 100 may receive the interrupt from the PMIC 110 and may forward the interrupt information to the microcontroller 120 after reading the information over the communication interface 118. The microcontroller 120 may interpret the interrupt message to determine whether there is an overcurrent condition or event occurring on the VCC rail, VNN rail, or both rails of the SOC 100. If there is an overcurrent condition on one or both of the VNN and VCC rails, the microcontroller 120 may decide to lower the operating points of one or more of the other components on the SOC 100. The decision of the microcontroller 120 may be aided in part by its knowledge of the present activity on SOC 100.

For instance, if the VCC rail current has just crossed into an excessive current level, the microcontroller 120 may throttle (e.g., lower the operating frequency or voltage of) the CPU 122 since the CPU 122 is powered by the VCC rail. Lowering the operating frequency or voltage of a component may also be referred to as lowering the operating point for the component referenced. Throttling the CPU 122 into a low frequency mode (LFM) may cause a subsequent current drop on the VCC rail. After a sufficient period of time in this LFM operating state, the comparator circuit that monitors the VCC rail may recognize that the current on the VCC rail has crossed back to normal levels and may begin the process of generating another interrupt from the PMIC 110. This time the interrupt, when read by the microcontroller 120, may indicate normal current levels, giving the microcontroller 120 the option of increasing the operating point for the CPU 122 if warranted. The embodiments are not limited to this example.

Similarly, if the VNN rail current has just crossed into an excessive current level, the microcontroller 120 may throttle the GFX 124, for instance, into a reduced performance mode since the GFX 124 is powered by the VNN rail. Once the VNN rail current returns to normal levels, another interrupt may be sent to the microcontroller 120 indicative of the current level returning to a normal range. The microcontroller 120 has the option of increasing the operating point for the GFX 124 if warranted. The embodiments are not limited to this example. For instance, any one or more of the other VNN powered components (video component 126, camera 126, display 130, SRAMs 132 and LDOs 134) could have had its operating point changed by the microcontroller 120 based on the present activity of the SOC 100.

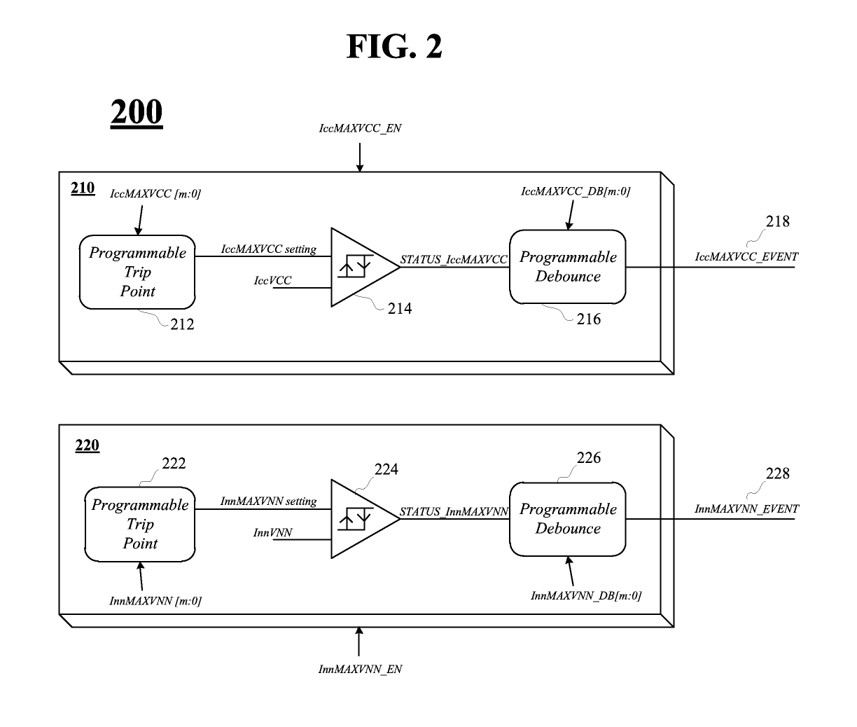

FIG. 2 illustrates one embodiment of comparator logic circuits 200. A current comparator is a device that compares two currents and switches its output to indicate which is larger. The current comparator logic circuits 200 may be programmed to receive as one input a threshold setting labeled IccMAXVCC setting in comparator 214 and IccMAXVNN setting in comparator 224 by programmable trip point components 212 and 222 respectively. The other comparator input may be IccVCC (the current presently on the VCC rail) for comparator 214 and IccVNN (the current presently on the VNN rail) for comparator 224. Whenever IccMAXVCC setting is greater than IccVCC for comparator 214, the current on the VCC rail is within normal levels. However, when IccMAXVCC setting is less than IccVCC for comparator 214, the VCC rail current has exceeded normal levels and the output of comparator 214 may be set to an overcurrent condition and given a logical value of “1”. The output may be labeled STATUS_IccMAXVCC and can be either logical “0” or “1” and may be indicative of either normal or excessive current on the VCC rail.

Similarly, when IccMAXVNN setting is greater than IccVNN for comparator 224, the current on the VNN rail is within normal levels. However, when IccMAXVNN setting is less than IccVNN for comparator 224, the VNN rail current has exceeded normal levels and the output of comparator 224 may be set to an overcurrent condition and given a logical value of “1”. The output may be labeled STATUS_IccMAXVNN and can be either logical “0” or “1” and may be indicative of either normal or excessive current on the VNN rail.

The STATUS_IccMAXVCC output from comparator 214 may be fed to a programmable debounce component 216 to ensure a clean transition from one state to another. For instance, if the debounce is set to 500 ns and the STATUS_IccMAXVCC is “1” for only 200 ns, the momentary glitch will not cause a spurious transition. The output of the programmable debounce component 216 may be a data signal labeled IccMAXVCC_EVENT 218 which may be a logical “0” or “1” that may be indicative of whether the STATUS_IccMAXVCC logical value has changed. If STATUS_IccMAXVCC has changed from a “0” to a “1” or vice versa then IccMAXVCC_EVENT 218 may be set to “1”. If STATUS_IccMAXVCC has not changed then IccMAXVCC_EVENT 218 may be set to “0”. Thus, any change on IccMAXVCC_EVENT 218, “0” to “1” or “1” to “0”, may cause an interrupt to be sent to the SOC 100.

Similarly, the STATUS_IccMAXVNN output from comparator 214 may be fed to a programmable debounce component 226 similar to that described above. The output of the programmable debounce component 226 may be a data signal labeled IccMAXVNN_EVENT 228 which may be a logical “0” or “1” that may be indicative of whether the STATUS_IccMAXVNN logical value has changed. If STATUS_IccMAXVNN has changed from a “0” to a “1” or vice versa then IccMAXVNN_EVENT 228 may be set to “1”. If STATUS_IccMAXVNN has not changed then IccMAXVCC_EVENT 228 may be set to “0”.

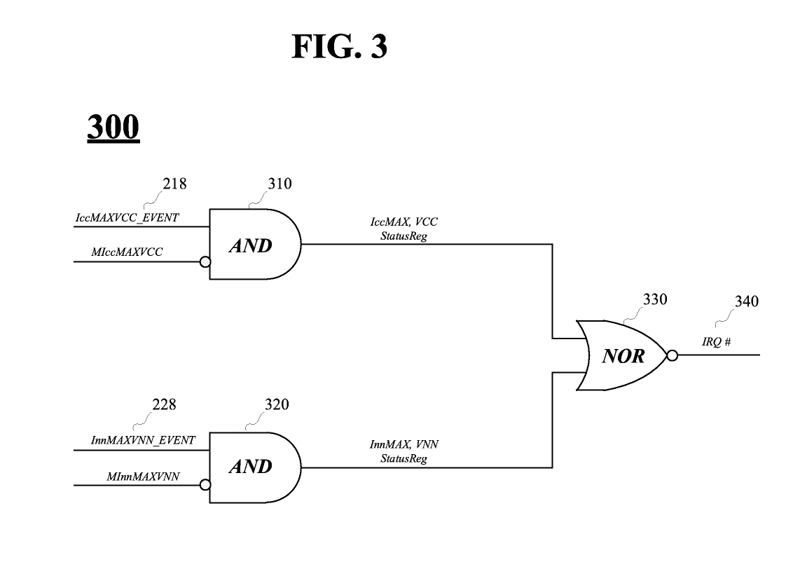

FIG. 3 illustrates one embodiment of a logic circuit 300 within the interrupt management component 114 that is operative to determine whether an interrupt should be generated. A first AND gate 310 may receive input pertaining to the VCC rail current and a second AND gate 320 may receive input pertaining to the VNN rail current. The outputs of each AND gate 310, 320 may then be fed to an NOR gate 330 that may determine whether an interrupt request (IRQ#) 340 should fire.

The AND gate 310 may receive as input the IccMAXVCC_EVENT 218 from comparator circuit 214 as well as a mask setting labeled MIccMAXVCC typically set to logical “0” so as to have the AND gate 310 key off the IccMAXVCC_EVENT 218 input. The mask, if set to “1”, will prevent the interrupt IRQ#340 from firing. The mask may be set to “1” temporarily while the system handles the interrupt or if the system decides not to deal with that interrupt at that moment because the system is busy or does not think the interrupt is needed.

When IccMAXVCC_EVENT 218 is set to a logical “1” it is an indication that the current on the VCC rail has crossed the threshold setting into excessive levels or back to normal levels. Either way, it will cause the interrupt IRQ#340 to fire if the mask input is set to logical “0”. Since IccMAXVCC_EVENT 218 and the inverted mask bit are both “1” the AND gate 310 output will also be “1”. The AND gate 310 output is an input to the NOR gate 330 and its output will be “1” if either of its inputs are set to “1”. A NOR gate 330 output of “1” may cause interrupt IRQ#340 to fire. In addition, IRQ#340 is packed with data in status registers (e.g., VCC status register) that indicate whether the cause of the IRQ#340 is the result of entering an overcurrent situation or exiting an overcurrent situation. This is illustrated on the output of AND gate 310 in which the IccMAX bit in the VCC status register is used by IRQ#340 to notify the SOC of the event.

Similarly, when IccMAXVNN_EVENT 228 is set to a logical “1” it is an indication that the current on the VNN rail has crossed the threshold setting into excessive levels or back to normal levels. Either way, it will cause the interrupt IRQ#340 to fire if the mask input is set to logical “1”. Since IccMAXVNN_EVENT 228 and the inverted mask bit are both “1” the AND gate 320 output will also be “1”. The AND gate 320 output is an input to the NOR gate 330 and its output will be “1” if either of its inputs are set to “1”. An NOR gate 330 output of “1” may cause interrupt IRQ#340 to fire. In addition, IRQ#340 is packed with data in status registers (e.g., VNN status register) that indicate whether the cause of the IRQ#340 is the result of entering an overcurrent situation or exiting an overcurrent situation. This is illustrated on the output of AND gate 320 in which the IccMAX bit in the VNN status register is used by IRQ#340 to notify the SOC of the event.

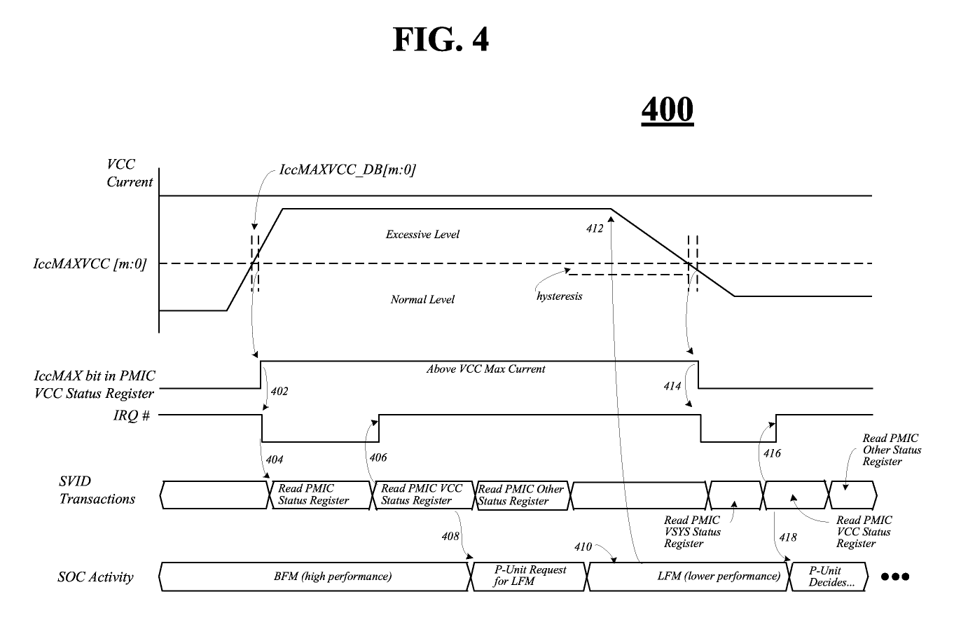

FIG. 4 illustrates one embodiment of a timing diagram 400 for monitoring and reacting to current changes on the VCC rail of the SOC 100. The various elements shown on the timing diagram include a graph of VCC current levels over time, a digital representation of the time VCC current levels are at or above maximum current levels, a digital representation of the interrupt asserting and clearing its pin level, a timeline of the microcontroller reading the interrupt status registers, and a high level description of SOC 100 activity.

In this example, as current on the VCC rail rises, it may cross a threshold setting labeled IccMAXVCC[m:0]. This event may trigger an interrupt IRQ#340 from the interrupt management component 114 at 402 in which an IccMAX bit in a VCC status register may be set to indicate an overcurrent condition on the VCC rail. The interrupt may be sent from the PMIC 110 to the SOC 100. The microcontroller 120 of SOC 100 may read the status registers of the interrupt using a StatusReg command at 404. Upon reading the VCC status register at 406 the microcontroller 120 may see that the IccMAX bit for the VCC rail is set. The pin level for the interrupt (IRQ#) 340 may then be de-asserted. The microcontroller 120 may then decide to lower the CPU 122 frequency to run in LFM mode and may send a request at 408 to CPU 122 indicative of same. CPU 122 may lock in to the lower frequency and may begin running in LFM mode at 410. Since CPU 122 may now be operating in LFM mode, the current on the VCC rail may begin to drop at 412. When the current on the VCC rail drops below the threshold setting of IccMAXVCC[m:0] another interrupt (IRQ#) 340 may be triggered from PMIC 110 to microcontroller 120 on SOC 100 at 414. The microcontroller 120 of SOC 100 may read the status registers of the interrupt as described above. Upon reading the VCC status register at 416 the microcontroller 120 may see that the IccMAX bit for the VCC rail may have been cleared. The pin level for IRQ#340 may then be de-asserted. The microcontroller 120 may then decide to restore the CPU 122 to its previous operating point at 418. The microcontroller does not necessarily have to restore the operating point of CPU 122 if it decides that keeping the CPU 122 in LFM or changing the operating point to a different mode is unwarranted. The microcontroller 120 may use its knowledge of present SOC 100 activity to make its decision. However, it now may know that the current on the VCC rail is back within normal levels.

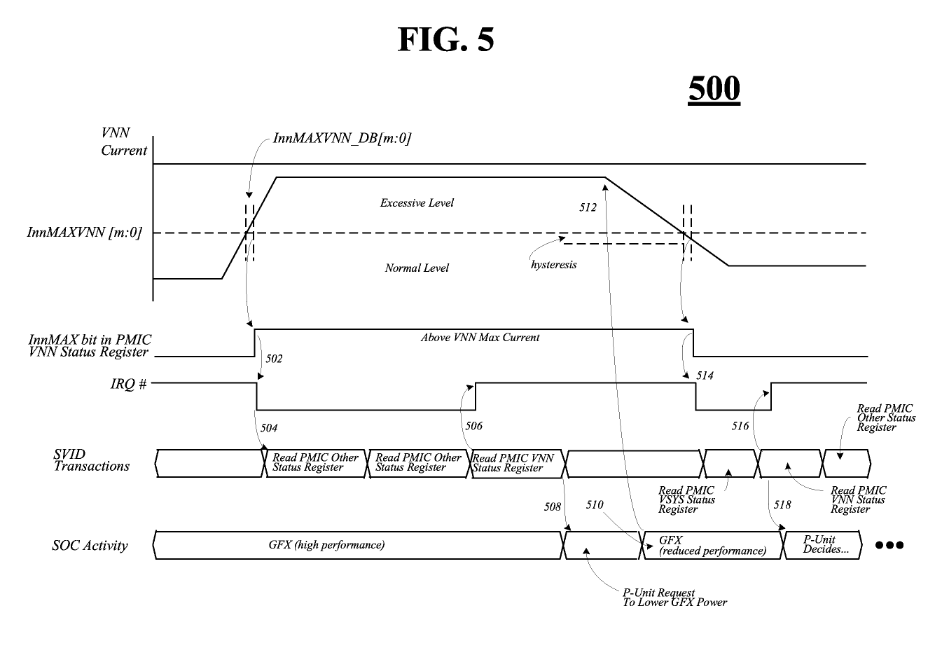

FIG. 5 illustrates one embodiment of a timing diagram 500 for monitoring and reacting to current changes on the VNN rail of the SOC 100. The various elements shown on the timing diagram include a graph of VNN current levels over time, a digital representation of the time VNN current levels are at or above maximum current levels, a digital representation of the interrupt asserting and clearing its pin level, a timeline of the microcontroller reading the interrupt status registers, and a high level description of SOC 100 activity.

In this example, as current on the VNN rail rises, it may cross a threshold setting labeled IccMAXVNN[m:0]. This event may trigger an interrupt IRQ#340 from the interrupt management component 114 at 502 in which an IccMAX bit in a VNN status register may be set to indicate an overcurrent condition on the VNN rail. The interrupt may be sent from the PMIC 110 to the SOC 100. The microcontroller 120 of SOC 100 may read the status registers of the interrupt using a StatusReg command at 504. Upon reading the VNN status register at 506 the microcontroller 120 may see that the IccMAX bit for the VNN rail is set. The pin level for IRQ#340 may then be de-asserted. The microcontroller 120 may then decide to lower the GFX 124 frequency to run in a reduced performance mode and may send a request at 508 to GFX 124 indicative of same. GFX 124 may lock in to the reduced performance mode at 510. Since GFX 124 may now be operating in a reduced performance mode, the current on the VNN rail may begin to drop at 512. When the current on the VNN rail drops below the threshold setting of IccMAXVNN[m:0] another interrupt IRQ#340 may be triggered from PMIC 110 to microcontroller 120 on SOC 100 at 514. The microcontroller 120 of SOC 100 may read the status registers of the interrupt as described above. Upon reading the VNN status register at 516 the microcontroller 120 may see that the IccMAX bit for the VNN rail may have been cleared. The pin level for IRQ#340 may then be de-asserted. The microcontroller 120 may then decide to restore the GFX 124 to its previous operating point at 518. The microcontroller does not necessarily have to restore the operating point of GFX 124 if it decides that keeping the GFX 124 in reduced performance mode or changing the operating point to a different mode is unwarranted. The microcontroller 120 may use its knowledge of present SOC 100 activity to make its decision. However, it now may know that the current on the VNN rail is back within normal levels.

Included herein are one or more flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

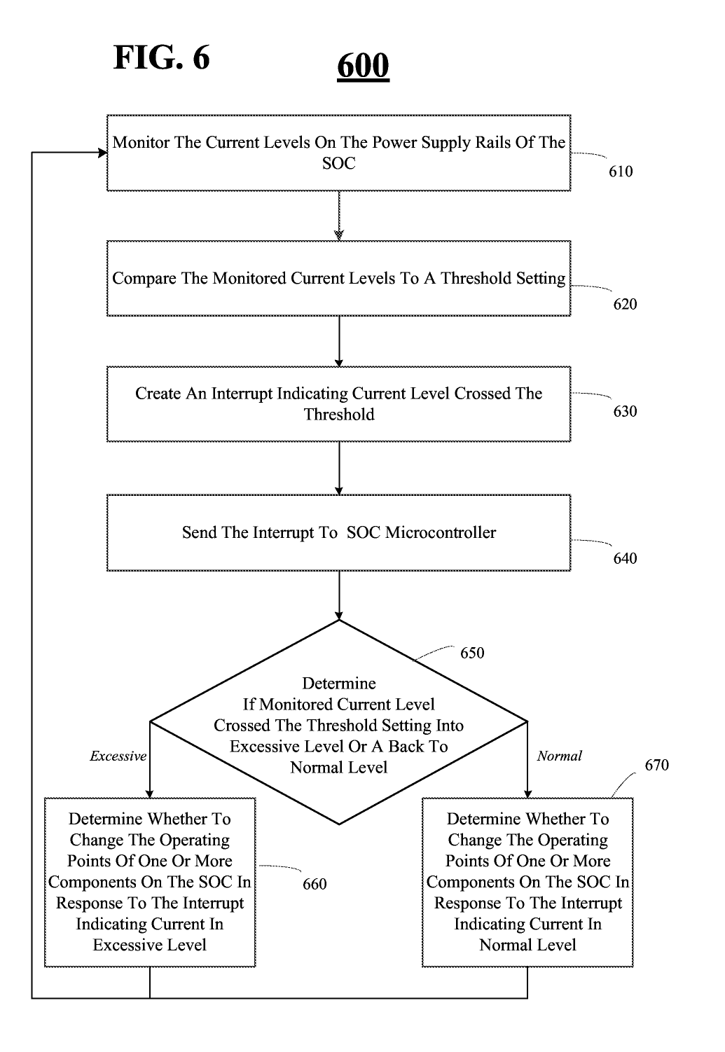

FIG. 6 illustrates one embodiment of a logic flow diagram 600. The logic flow 600 may be representative of some or all of the operations executed by one or more embodiments described herein.

In the illustrated embodiment shown in FIG. 6, the logic flow 600 may monitor the current levels on the power supply rails of the SOC 100 at block 610. For example, current comparators 214, 224 may be programmed to receive as one input a threshold setting labeled IccMAXVCC setting in comparator 214 and IccMAXVNN setting in comparator 224 by programmable trip point components 212 and 222 respectively. The other comparator input may be IccVCC (the current presently on the VCC power supply rail) for comparator 214 and IccVNN (the current presently on the VNN power supply rail) for comparator 224. The embodiments are not limited to this example.

The logic flow 600 may compare the monitored current levels on the VCC and VNN rails of the SOC 100 to the threshold setting at block 620. For example, whenever IccMAXVCC setting is greater than IccVCC for comparator 214, the VCC rail is within normal levels. However, when IccMAXVCC setting is less than IccVCC for comparator 214, the VCC rail has exceeded normal levels and the output of comparator 214 may be set to an overcurrent condition and given a logical value of “1”. Similarly, whenever IccMAXVNN setting is greater than IccVNN for comparator 224, the VNN rail is within normal levels. However, when IccMAXVNN setting is less than IccVNN for comparator 224, the VNN rail has exceeded normal levels and the output of comparator 224 may be set to an overcurrent condition and given a logical value of “1”. The embodiments are not limited to this example.

The logic flow 600 may create an interrupt indicating the current level has crossed the threshold setting at block 630. For example, within the interrupt management component 114, a first AND gate 310 may receive input pertaining to the VCC rail and a second AND gate 320 may receive input pertaining to the VNN rail. The outputs of each AND gate 310, 320 may then be fed to an NOR gate 330 that may determine whether an interrupt request (IRQ#) 340 should fire. The embodiments are not limited to this example.

The logic flow 600 may send the interrupt to a microcontroller 120 on SOC 100 at block 640. For example, the interrupt IRQ#340 may be forwarded from the interrupt management component 114 within PMIC 110 to the communication interface 114. The communication interface 114 may then forward the interrupt out of the PMIC 110 to the communication interface 118 within SOC 100. The embodiments are not limited to this example.

The logic flow 600 may determine whether current levels on the VCC and VNN rails of the SOC 100 have crossed the threshold setting into or out of excessive levels at block 650. For example, the interrupt may include data indicative of whether the current level for the VCC rail or the VNN rail has crossed the threshold setting into an excessive level or has crossed the threshold setting into a normal level. The interrupt data may be an IccMAX bit in a VCC status register that is set to indicate an overcurrent condition on the VCC rail and/or an IccMAX bit in a VNN status register that is set to indicate an overcurrent condition on the VNN rail. The embodiments are not limited to this example.

The logic flow 600 may determine whether to change the operating conditions of one or more SOC components in response to the interrupt indicating current has crossed into the excessive level at block 660. For example, if the VCC rail current has just crossed into an excessive current level, the microcontroller 120 may lower the operating point of the CPU 122 since the CPU 122 is powered by the VCC rail. Forcing the CPU 122 into a low frequency mode (LFM) may cause a current drop on the VCC rail. Similarly, if the VNN rail current has just crossed into an excessive current level, the microcontroller 120 may lower the GFX 124 into a reduced performance mode since the GFX 124 is powered by the VNN rail. The embodiments are not limited to this example.

The logic flow 600 may determine whether to change the operating conditions of one or more SOC components in response to the interrupt indicating current has crossed out of the excessive level at block 670. For example, if the VCC rail current has just crossed back into a normal current level, the microcontroller 120 may consider raising the operating point of the CPU 122. Similarly, if the VNN rail current has just crossed back into a normal current level, the microcontroller 120 may consider raising the GFX 124 into a high performance mode. The embodiments are not limited to this example.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus comprising:
one or more comparator circuits operative to monitor a current level on one or more power supply rails of a processing unit and determine if the current level on the one or more power supply rails crosses a threshold setting, the threshold setting indicative of an excessive level of current;
an interrupt management component communicatively coupled with the one or more comparator circuits, the interrupt management component operative to:
create an interrupt when the monitored current level crosses the threshold setting, the interrupt including data indicative of whether the current level for the one or more power supply rails has crossed the threshold setting into the excessive level or has crossed the threshold setting into the normal level; and
send the interrupt to the processing unit.

2. The apparatus of claim 1 wherein the processing unit is a system on a chip (SOC).

3. The apparatus of claim 1 wherein the threshold setting is programmable.

4. The apparatus of claim 1 wherein the interrupt management component includes one or more power supply status registers.

5. The apparatus of claim 4 wherein the interrupt management component is operative to set a status bit in a power supply status register, the status bit indicative of the current level on the power supply status register crossing the threshold setting into the excessive level.

6. The apparatus of claim 4 wherein the interrupt management component is operative to clear a status bit in a power supply status register, the status bit indicative of the current level on the power supply status register crossing the threshold setting into the normal level.

7. An apparatus comprising:
a microcontroller operative to:
receive an interrupt from a power management integrated circuit (PMIC), the interrupt indicative of when a monitored current level crosses a threshold setting for a power supply rail of the apparatus, the interrupt including data indicative of whether the current level for the power supply rail has crossed the threshold setting into the excessive level or has crossed the threshold setting into the normal level;
evaluate the activity occurring on the apparatus; and
determine whether change an operating point of one or more components on the apparatus in response to the interrupt.

8. The apparatus of claim 7 wherein the microcontroller is operative to lower an operating point of one or more components on the apparatus in response to the interrupt.

9. The apparatus of claim 7 wherein the microcontroller is operative to increase an operating point of one or more components on the apparatus in response to the interrupt.

10. The apparatus of claim 7 comprising a system on a chip (SOC).

11. The apparatus of claim 7 wherein the SOC includes the microcontroller.

12. The apparatus of claim 7 wherein the one or more components under control of a SOC includes a display.

13. The apparatus of claim 7 wherein the interrupt is received via a low latency interrupt channel over a communication interface.

14. A method comprising:
monitoring the current level on a power supply rail of a system on a chip (SOC);
determining if the current level on the power supply rail crosses a threshold setting, the threshold setting indicative of an excessive level of current;
creating an interrupt when the monitored current level for the power supply rail crosses the threshold setting, the interrupt including data indicative of whether the current level has crossed the threshold setting; and
sending the interrupt to a microcontroller over a communication interface.

15. The method of claim 14 comprising:
reading the interrupt; and
determining whether to change the operating points of one or more components on the SOC if the interrupt indicates that the current level on the power supply rail has crossed the threshold level.

16. The method of claim 15 comprising:
changing the operating points of one or more components on the SOC in response to the interrupt.

17. The method of claim 15 comprising evaluating the activity occurring on the SOC to determine which components to change the operating points for if the current level on the power supply rail has crossed the threshold level.

18. A system comprising:
a power management integrated circuit (PMIC) comprising:
one or more comparator circuits operative to monitor a current level on one or more power supply rails of a processing unit and determine if the current level on the one or more power supply rails crosses a threshold setting, the threshold setting indicative of an excessive level of current;
an interrupt management component communicatively coupled with the one or more comparator circuits, the interrupt management component operative to create an interrupt when the monitored current level crosses the threshold setting, the interrupt including data indicative of whether the current level for the one or more power supply rails has crossed the threshold setting; and send the interrupt; and
a system on a chip (SOC) comprising a microcontroller operative to:
receive the interrupt from the PMIC;
evaluate the activity occurring on the SOC; and
determine whether to change an operating point of one or more components on the SOC in response to the interrupt.

19. The system of claim 18 wherein the threshold setting is programmable.

20. The system of claim 18 wherein a programmable minimum amount of time that the threshold setting is crossed must elapse before creating the interrupt.

21. The system of claim 18 wherein the interrupt can be masked.

22. The system of claim 18 wherein the microcontroller is operative to change an operating point of one or more components on the SOC in response to the interrupt.

23. The system of claim 22 wherein the microcontroller is operative to lower an operating point of one or more components on the SOC in response to the interrupt.

24. The system of claim 22 wherein the microcontroller is operative to increase an operating point of one or more components on the SOC in response to the interrupt.
